(19) United States
(12) Patent Application Publication
(10) Pub. No.: US 2026/0046904 A1
(43) Pub. Date: Feb. 12, 2026

(54) MODE 2 RESOURCE ALLOCATION FOR SIDELINK TRANSMISSIONS IN UNLICENSED SPECTRUM

(71) Applicant: Apple Inc., Cupertino, CA (US)

(72) Inventors: Chunxuan Ye, San Diego, CA (US); Ankit Bhamri, Bad Nauheim (DE); Chunhai Yao, Beijing (CN); Dawei Zhang, Saratoga, CA (US); Haitong Sun, Cupertino, CA (US); Hong He, San Jose, CA (US); Huaning Niu, San Jose, CA (US); Seyed Ali Akbar Fakoorian, San Diego, CA (US); Wei Zeng, Saratoga, CA (US); Weidong Yang, San Diego, CA (US)

(21) Appl. No.: 19/103,161

(22) PCT Filed: Aug. 12, 2022
(86) PCT No.: PCT/CN2022/112087

§ 371 Date: Feb. 11, 2025

(51) Int. Cl. H04W 72/25; H04W 74/0808

(52) U.S. Cl. CPC H04W 72/25; H04W 74/0808

(57) ABSTRACT

Systems and processes are described for resource allocation for new radio (NR) sidelink transmissions in an unlicensed spectrum (NR-U). More specifically. the resource allocation is performed for mode 2 sidelink transmissions. The methods and systems are configured for excluding resources from allocation by transmitting UE near resources reserved by a reserving UE. The methods and systems are configured for prioritizing resources for allocation by a transmitting UE near resources already allocated to the transmitting CE.

### TECHNICAL FIELD

This disclosure relates generally to sidelink (SL) transmissions in wireless communications.

### BACKGROUND

Wireless communication systems are rapidly growing in usage. Further, wireless communication technology has evolved from voice-only communications to also include the transmission of data, such as Internet and multimedia content, to a variety of devices. To accommodate a growing number of devices communicating both voice and data signals, many wireless communication systems share the available communication channel resources among devices.

### SUMMARY

This specification describes processes for resource allocation for new radio (NR) sidelink transmissions in an unlicensed spectrum (NR-U). More specifically, the resource allocation is performed for mode 2 sidelink transmissions. A mode 2 resource selection procedure is enhanced to accommodate shared spectrum channel access. Systems and processes described in this specification support multi-consecutive slots transmission for NR sidelink operation in the unlicensed spectrum for each of channel access, resource allocation, and physical channel design. The systems and processes described in this specification enable enhancement between the end of the LBT procedure and the start of the SL transmission to retain channel access for a UE. The systems and operations described herein can be related to Release 18 of the 5th Generation (5G) of the 3rd Generation Partnership Project (3GPP).

Generally, unlicensed spectrum, or free bands, that are available for transmissions. For example, these bands can include 2.4 and 5 GHz. A Listen Before Talk (LBT) protocol enables user equipment (UEs) to use the unlicensed spectrum while maintaining equitable access with respect to the WiFi devices. Specifically, the processes herein are to avoid collisions with WiFi transmissions. The systems and processes described in this specification are configured for mode 2 in which Uu operation for mode 2 uses the licensed spectrum only (e.g., RAN1, RAN2, and RAN4). Generally, the channel access mechanisms from NR-U are reused for unlicensed sidelink operations.

Generally, the sidelink mode 2 resource allocation (RA) includes a dynamic grant. Each of Type 1 and Type 2 configured grants are supported as a baseline for sidelink operation in a shared carrier, subject to applicable regional regulations. At least in dynamic channel access, the UE selects resources for SL operation, as specified in 3GPP TS 37.213. The UE performs Type 1 or one of the Type 2 LBT operations before SL transmission using the allocated resource(s). The UE still performs the LBT operations because of the potential conflict with WiFi transmissions. The LBT operations are performed in compliance with a transmission gap and LBT sensing idle time requirements, such as those specified in TS 37.213.

The systems and processes described in this specification are configured to enable a given UE (e.g., a transmitting UE) to avoid selecting a resource slot that is in conflict with the LBT resources of another UE (e.g., a blocked UE). The blocked UE can perform LBT operations occupying the channel prior to the blocked UE's reserved slot. The transmitting UE does not select resources during this LBT idle time for the blocked UE to allow the blocked UE to perform its LBT operations. The system and processes are configured to enable the given UE to avoid allocating a resource just after another UE (e.g., a blocking UE). The blocking UE would block LBT operations of the transmitting UE prior to the reserved resource for the transmitting UE. The resource allocation processes described in this specification manage both these blocking and blocked scenarios for the transmitting UE and avoid collisions of UE operations in the unlicensed spectrum.

The systems and processes described in this specification enable a UE to more efficiently allocate resources near or next to a slot that is already allocated for the UE SL operations. In this example, the UE already has channel access for a given slot. The resources immediately prior and subsequent to this allocated slot are prioritized for resource allocation for that UE. For example, the UE can prioritize allocation of the channel just prior to an existing allocated slot. The UE can then perform type 1 LBT operations once, before the newly allocated slot, for both the newly allocated resources and the previously allocated slot, as the UE need only access the channel once for both sets resources. Additionally, the UE can select resources just after the previously allocated slot. The UE need only perform LBT operations once for both resources to access the channel. Each of these approaches simplifies channel access for the UE and increases efficiency of channel access by the UE for NR-U SL operations.

The systems and processes described in this specification enable one or more advantages. The systems and processes enhance the resource selection procedure due to shared spectrum channel access. The systems and processes enable a UE to avoid or mitigate mutual blocking in a transmission timeline using the enhanced resource selection procedure. The systems and methods described herein enhance resource allocation on shared spectrum channel access to prevent collisions, such as with WiFi transmissions. The enhanced resource allowance for unlicensed SL transmissions in include a timeline consideration for LBT sensing to allow for LBT operations in the dynamic allocation.

A SL HARQ report is generated for a node (e.g., a base station, next generation node gNB, access point, etc.) for scenarios including multiple PSFCH occasions. The enhanced resource allocation updates the SL configured grant. The enhanced resource allocation accommodates timeline restrictions for resource re-evaluation and pre-emption on shared spectrum channel access. For example, the SL UE performs Type 1 LBT operations or Type 2 LBT operations before SL transmission. For a Type 1 LBT, which is a more general LBT, the LBT sensing duration is flexible depending on a Channel access priority class (CAPC) value. A transmitted two-bit value indicates which channel access priority is being used by an initiating UE to acquire the channel occupancy time (COT) for a SL transmission. For a type 2 LBT, a sensing duration is selected (e.g., 0-25 microseconds (μs)) based on the specific LBT operations being performed. The enhanced resource allowance enables the different LBT operations to be performed without collision.

The one or more advantages can be enabled by at least one or more of the following embodiments.

The embodiments are shown below in an examples section.

In some implementations, the process is performed by a network element, a UE, or base station, such as a next generation node (gNB). In some implementations, one or more non-transitory computer readable media store instructions that when executed by at least one processing device cause the at least one processing device (or another device in communication with the at least one processing device) to perform the process.

The details of one or more implementations are set forth in the accompanying drawings and the description below. Other features and advantages will be apparent from the description and drawings, and from the claims.

### BRIEF DESCRIPTION OF DRAWINGS

FIG. 1 illustrates a wireless network, in accordance with some embodiments.

FIG. 2A shows an illustration of an example transmission timeline for a UE for SL transmissions for mode 2.

FIG. 2B shows an illustration of an example transmission timeline for a UE for SL transmissions for mode 2.

FIG. 3 shows an illustration of an example transmission timeline for a UE for SL transmissions for mode 2.

FIGS. 4-9 each shows a flow diagram of an example process for SL transmissions for a UE in mode 2.

FIG. 10 illustrates a user equipment (UE), in accordance with some embodiments.

FIG. 11 illustrates an access node, in accordance with some embodiments.

Like reference symbols in the various drawings indicate like elements, according to various embodiments herein.

### DETAILED DESCRIPTION

This specification describes systems and processes to enable enhanced sidelink (SL) resource allocation for transmissions in mode 2 when using an unlicensed spectrum (NR-U), such as by user equipment (UE). The systems and processes described in this specification are configured to enable a given UE (e.g., a transmitting UE) to avoid selecting a resource slot that is in conflict with the LBT resources of another UE (e.g., a blocked UE). The blocked UE can perform LBT operations occupying the channel prior to the blocked UE's reserved slot. The transmitting UE does not select resources during this LBT idle time for the blocked UE to allow the blocked UE to perform its LBT operations. The system and processes are configured to enable the given UE to avoid allocating a resource just after another UE (e.g., a blocking UE). The blocking UE would block LBT operations of the transmitting UE prior to the reserved resource for the transmitting UE. The resource allocation processes described in this specification manage both these blocking and blocked scenarios for the transmitting UE and avoid collisions of UE operations in the unlicensed spectrum.

The systems and processes described in this specification enable a UE to more efficiently allocate resources near or next to a slot that is already allocated for the UE SL operations. In this example, the UE already has channel access for a given slot. The resources immediately prior and subsequent to this allocated slot are prioritized for resource allocation for that UE. For example, the UE can prioritize allocation of the channel just prior to an existing allocated slot. The UE can then perform type 1 LBT operations once, before the newly allocated slot, for both the newly allocated resources and the previously allocated slot, as the UE need only access the channel once for both sets resources. Additionally, the UE can select resources just after the previously allocated slot. The UE need only perform LBT operations once for both resources to access the channel. Each of these approaches simplifies channel access for the UE and increases efficiency of channel access by the UE for NR-U SL operations.

Generally, the SL UE performs Type 1 LBT operations or one of the one or more sets of Type 2 LBT operations before performing an SL transmission. The different LBTs have different respective configurations. The Type 1 LBT includes an LBT sensing duration that is flexible depending on an associated CAPC value, as shown in Table 1 or Table 2, below. A two-bit value is generated that indicates which channel access priority is being used by the initiating device to acquire the COT for a SL transmission. Generally, either the downlink (DL) CAPC value from Table 1 or the uplink (UL) CAPC value from Table 2 can be used for the SL resource allocation. Generally, a maximum LBT sensing idle time is 1023*9 μs (e.g., the sensing slot duration), which is about 9 milliseconds (ms), or several slots. For type two, the following configurations are typically used. A Type 2A LBT is associated with a LBT sensing duration of 25 μs. A Type 2B LBT is associated with a sensing duration between 16 and 25 μs. A Type 2C LBT does not include a channel sensing operation before transmission. Rather, if the spectrum is free, it is used, without a countdown or calculation of the CW. A time gap to a previous transmission is less than 16 μs. A duration of a corresponding transmission is less than or equal to 584 μs.

TABLE 1
Downlink configurations for NR-U (gNB) for Type 1 LBT

| Channel Access | | | | | | |
|---|---|---|---|---|---|---|
| Priority Class | | | | | | |
| (p) | mₚ | CW_{min, p} | CW_{max, p} | T_{mcot, p} | | allowed CWₚsizes |
| 1 | 1 | 3 | 7 | 2 | ms | {3, 7} |
| 2 | 1 | 7 | 15 | 3 | ms | {7, 15} |
| 3 | 3 | 15 | 63 | 8 or 10 | ms | {18, 31, 63} |
| 4 | 7 | 15 | 1023 | 8 or 10 | ms | {15, 31, 63, 127, 255, 511, 1023} |

As shown in Table 1, mₚ is maximum number of transmission attempts for priority class p. CWₚ is a contention window for a given priority class p. CW_{max,p} is a maximum contention window for a given priority class, p. CW_{min,p} is a minimum contention window for a given priority class, p. T_{cot,pm} is a maximum channel occupancy time for a given priority class, p. According to the 3GPP standards, a device does not continuously transmit in the unlicensed spectrum for a period longer than T_{mcot,p}. The allowed CW sizes for each priority class for DL are shown in Table 1.

TABLE 2
Uplink configurations for NR-U (UE) for Type 1 LBT

| Channel | | | | | |
|---|---|---|---|---|---|
| Access | | | | | |
| Priority | | | | | |
| Class (p) | mₚ | CW_{min, p} | CW_{max, p} | T_{ulmcot, p} | allowed CWₚ sizes |
| 1 | 2 | 3 | 7 | 2 ms | {3, 7} |
| 2 | 2 | 7 | 15 | 4 ms | {7, 35} |
| 3 | 3 | 15 | 1023 | 6 ms or 10 ms | {15, 31, 63, 127, 255, 511, 1023} |
| 4 | 7 | 15 | 1023 | 6 ms or 10 ms | {15, 31, 63, 127, 255, 511, 1023} |

As shown in Table 2, mₚ is maximum number of transmission attempts for priority class p. CWₚ is a contention window for a given priority class p. CW_{max,p} is a maximum contention window for a given priority class, p. CW_{min,p} is a minimum contention window for a given priority class, p. T_{cot,pm} is a maximum channel occupancy time for a given priority class, p. According to the 3GPP standards, a device does not continuously transmit in the unlicensed spectrum for a period longer than T_{mcot,p}. The allowed CW sizes for each priority class for UL are shown in Table 2.

The enhanced resource allocation for SL transmissions using the unlicensed spectrum in mode 2 is based on the following process for SL transmissions. The systems and processes described herein enhance the mode 2 resource selection procedure due to shared spectrum channel access. The systems and processes described in this specification avoid or mitigate a mutual blocking issue between UEs by an enhanced mode 2 resource selection procedure. The systems and processes described in this specification avoid a type 1 LBT based on an enhanced mode 2 resource selection procedure.

A node (e.g., a gNB) is configured to schedule NR sidelink resources to be used by a UE for sidelink transmissions. For the mode 2 resource allocation scheme, the transmitting UE selects SL transmission resources based on the transmitting UE's own sensing and resource selection procedure. The resource selection procedures include identifying candidate resources as follows. The UE determines a resource selection window that is defined by a time span, such as time N+T₁, N+T₂. The total number of candidate resources is designated Mₜₒₜₐₗ. The UE is configured to determine a sensing window defined by a time span, such as time N−T₀, N−T_{proc,0}. The UE obtains initial Reference Signal Received Power (RSRP) threshold values. The UE sets a set of candidate resources S_{A} to all the resources in the resource selection window. The UE excludes resources from the set of candidate resources S_{A} if the UE does not sense in the sensing window with configured resource reservation periods before the candidate slot occurs. The UE excludes these resources from the set S_{A} of candidate resources if the following are true. First, if the UE receives SL control information (SCI) with a reservation of those resources, the UE excludes those resources from the set of candidate resources. Second, if the UE's RSRP measurement is higher than any RSRP thresholds (which depends also on data priority level of the reserving SCI), the UE excludes those resources from the set of candidate resources. The UE, if a number of resources in the set of candidate resources S_{A} is smaller than a threshold percentage of the total resources Mₜₒₜₐₗ, the UE increases a threshold by 3 dB on the RSRP threshold. The UE repeats the processes with the different threshold. If the threshold percentage is satisfied, the UE reports the set of candidate resources to the higher layer. In some implementations (e.g., NR V2X R16), the resource selection procedures include a step of randomly selecting resources from the identified candidate resources.

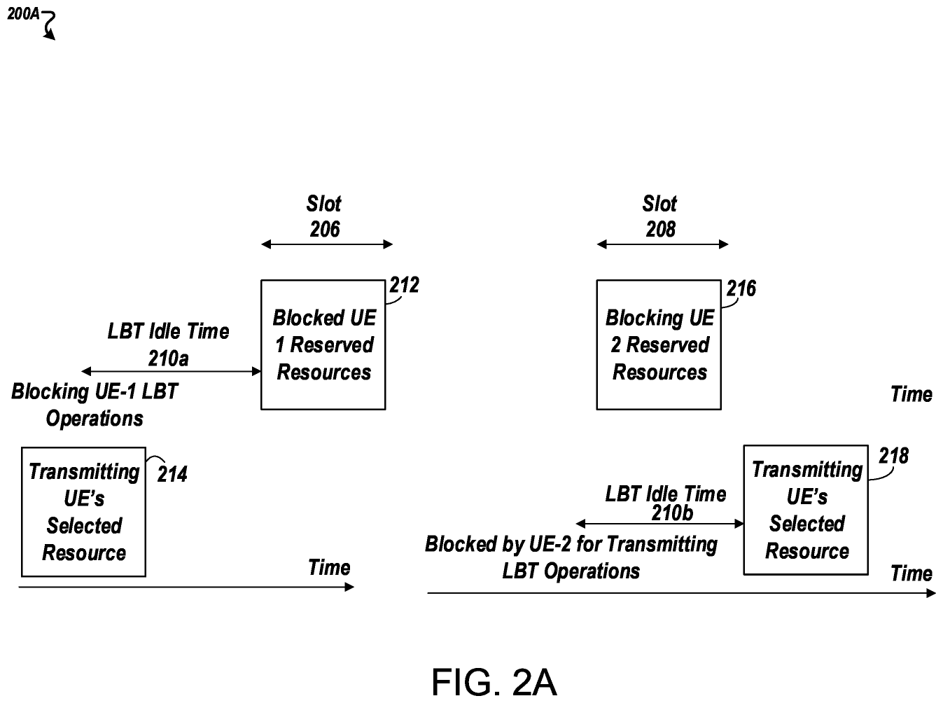

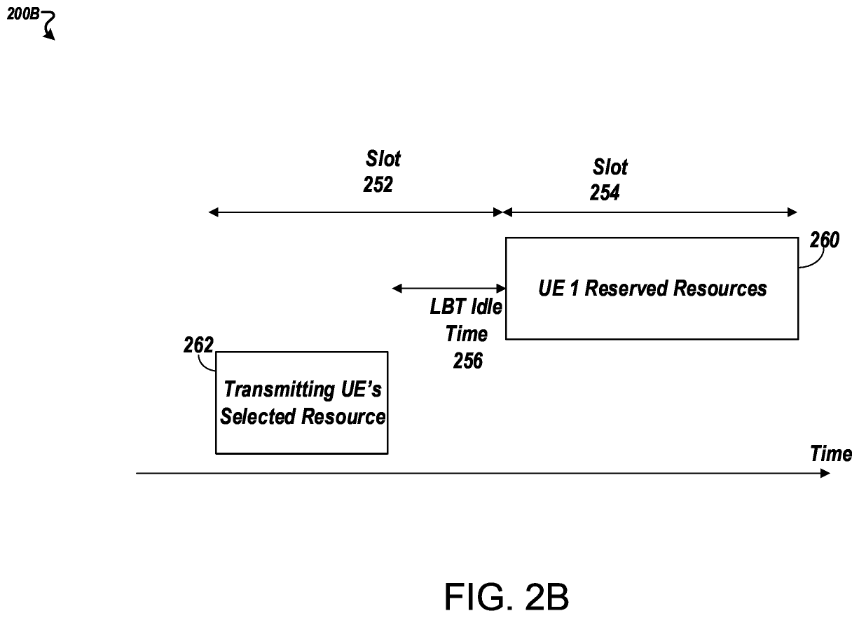

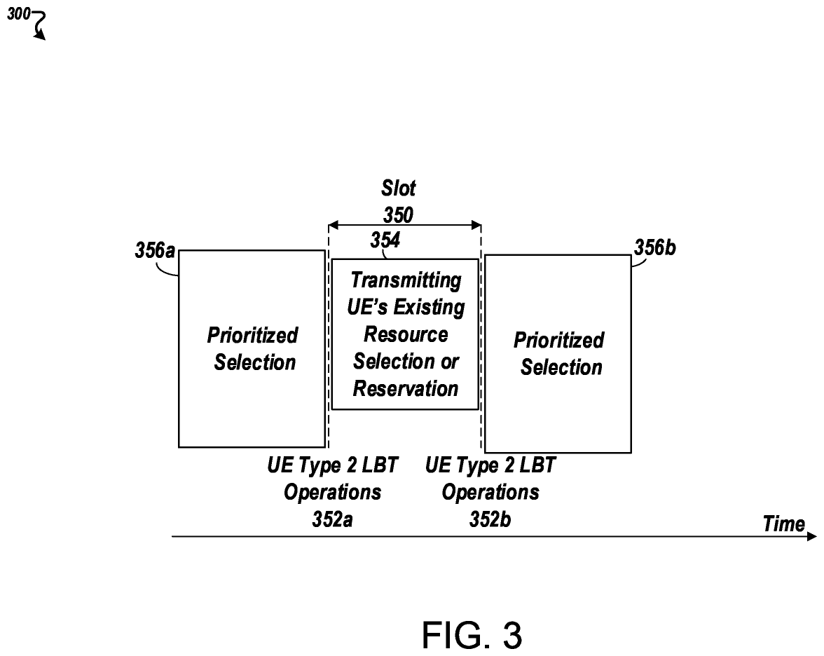

The node and/or UE can perform SL resource allocation for mode 2 in the unlicensed spectrum by adjusting the SL resource allocation process in one or more of the following ways. The UE performs resource selection in considering inter-UE blocking. This feature can be enabled or disabled for the UE. The inter-UE blocking consideration feature can be enabled per resource pool using a configuration or pre-configuration to consider “blocking” or “blocked” scenarios for the transmitting UE. The inter-UE blocking consideration feature can be enabled per-UE implementation. The inter-UE blocking feature includes consideration of blocking scenarios, blocked scenarios, or both blocking and blocked scenarios. Each of these considerations can be separately enabled or disabled during resource selection procedure. The resource selection procedures include identifying candidate resources. As stated previously, the UE performs a step, during a resource selection procedure, including exclusion of candidate resources from the set (S_{A}) of candidate resources. The UE can exclude a candidate single-slot resource (R_{x,y}) from the set S_{A} of candidate resources. The UE excludes the single-slot resource if the UE receives SCI along with the reservation of the candidate resources including the single slot resource (R_{x,y}). The UE excludes the candidate single-slot resource if the RSRP measurement on the reservation signal by the UE is higher than a given RSRP threshold. The decision to exclude the single-slot resource also depends on a data priority level of the reserving SCI. The RSRP threshold depends on the data priority, where both the transmitter UE's data priority (prio_TX) and the reserving UE's data priority (prio_RX) are considered. Generally, for a given pair of prio_TX and prio_RX, the RSRP threshold is obtained. The selection/exclusion of resources by the UE for this example is described in further detail with respect to FIGS. 2A-2B and FIG. 3.

The UE can perform resource selection for NR-U SL while considering channel occupancy time (COT) as a factor. The UE prioritizes resources in neighbor slots of existing reserved resources of the same UE. The UE maintains an existing COT duration and avoids type 1 LBT operations for the transmission on the existing reserved resource or for the transmission on the new reserved resource. As with the prior example, the prioritization of these resources can be enabled or disabled per resource pool, either by pre-configuration or during configuration of the resource allocation. In some implementations, the COT-based resources selection can depend on the data priority or CAPC index of the data. For example, for high priority data, the COT-based resource allocation by the UE may be enabled. In another example, for low priority data, the COT-based resource allocation by the UE may be disabled. Similarly, for a small CAPC index, the UE can disable the COT-based resource allocation process. In another example, the UE can disable the COT-based resource allocation process for a large CAPC index.

Each of these examples is subsequently described in further detail. Each of these examples enhances mode 2 resource allocation on shared spectrum channel access by providing a timeline consideration for LBT sensing.

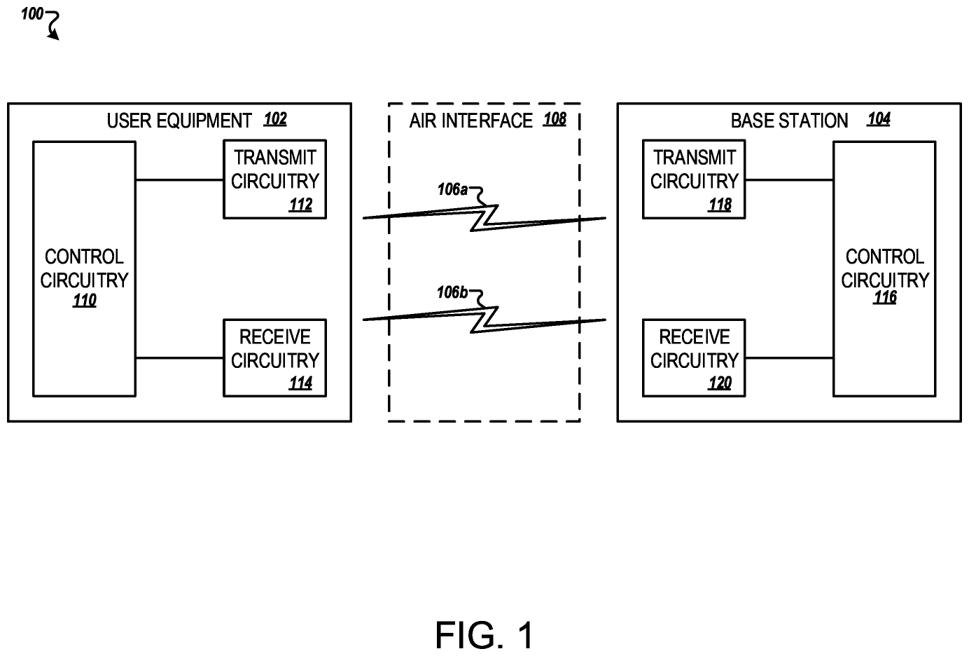

FIG. 1 illustrates a wireless network 100, in accordance with some embodiments. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

For purposes of convenience and without limitation, the wireless network 100 is described in the context of Long Term Evolution (LTE) and Fifth Generation (5G) New Radio (NR) communication standards as defined by the Third Generation Partnership Project (3GPP) technical specifications. More specifically, the wireless network 100 is described in the context of a Non-Standalone (NSA) networks that incorporate both LTE and NR, for example, E-UTRA (Evolved Universal Terrestrial Radio Access)-NR Dual Connectivity (EN-DC) networks, and NE-DC networks. However, the wireless network 100 may also be a Standalone (SA) network that incorporates only NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007;IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare monitoring, remote security surveillance systems, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some embodiments, such a broader network may be a wide area network operated by a cellular network provider, or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may be adapted to perform operations associated with selection of codecs for communication and to adaption of codecs for wireless communications as part of system congestion control. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry, including communications using codecs as described herein.

In various embodiments, aspects of the transmit circuitry 112, receive circuitry 114, and control circuitry 110 may be integrated in various ways to implement the circuitry described herein. The control circuitry 110 may be adapted or configured to perform various operations such as those described elsewhere in this disclosure related to a UE. The transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108. Similarly, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In embodiments, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108.

The control circuitry 116 may be adapted to perform operations for analyzing and selecting codecs, managing congestion control and bandwidth limitation communications from a base station, determining whether a base station is codec aware, and communicating with a codec-aware base station to manage codec selection for various communication operations described herein. The transmit circuitry 118 and receive circuitry 120 may be adapted to transmit and receive data, respectively, to any UE connected to the base station 104 using data generated with various codecs described herein. The transmit circuitry 118 may transmit downlink physical channels includes of a plurality of downlink sub-frames. The receive circuitry 120 may receive a plurality of uplink physical channels from various UEs, including the UE 102.

In this example, the one or more channels 106A, 106B are illustrated as an air interface to enable communicative coupling, and can be consistent with cellular communications protocols, such as a GSM protocol, a CDMA network protocol, a PTT protocol, a POC protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In embodiments, the UE 102 may directly exchange communication data via a ProSe interface. The ProSe interface may alternatively be referred to as a SL interface and may include one or more logical channels, including but not limited to a PSCCH, a PSSCH, a PSDCH, and a PSBCH.

FIG. 2A shows an illustration of an example transmission timeline 200a for a UE (e.g., UE 102 of FIG. 1) for SL transmissions. The UE is configured to perform SL resource allocation based on timeline restrictions in resource allocation. The timeline 200a shows operations for a UE that include an enhanced sidelink (SL) resource allocation for transmissions in mode 2 when using an unlicensed spectrum. The UE is configured to avoid selecting a resource slot that is in conflict with the LBT resources or slot 206 of another UE (e.g., a blocked UE). A blocked UE includes the UE that is performing operations on the resources 212 that have been reserved by the blocked UE, such as slot 206. The blocked UE can perform LBT operations occupying the channel prior during a LBT idle time 210a prior to the blocked UE's reserved slot 206. The transmitting UE does not select resources 214 during this LBT idle time 210a for the blocked UE. The blocked UE can perform its LBT operations during the LBT idle time 210a.

The transmitting UE avoids allocating a resource 218 just after the allocated resources 216 of another UE (e.g., a blocking UE). The blocking UE has reserved slot 208 in resources 216. The blocking UE blocks LBT operations during LBT idle time 210b for the transmitting UE (e.g., prior to the reserved resource 218 for the transmitting UE). The resource allocation of the transmitting UE manages both these blocking and blocked scenarios for the transmitting UE and avoids collisions of UE operations in the unlicensed spectrum.

The transmitting UE performs resource selection while considering inter-UE blocking. Consideration of inter-UE blocking is called an inter-UE blocking consideration feature. This feature can be enabled or disabled for the UE. The inter-UE blocking consideration feature can be enabled per resource pool using a configuration or pre-configuration to consider “blocking” or “blocked” scenarios for the transmitting UE. The inter-UE blocking consideration feature can be enabled per-UE implementation. The inter-UE blocking feature includes consideration of blocking scenarios, blocked scenarios, or both blocking and blocked scenarios. Each of these considerations can be separately enabled or disabled during resource selection procedure.

The resource selection procedure by the transmitting UE includes identifying candidate resources. As stated previously, during a resource selection procedure, the UE performs an exclusion step for excluding candidate resources from the set (SA) of candidate resources. The UE can exclude a candidate single-slot resource (R_{x,y}) from the set SA of candidate resources. The UE excludes the single-slot resource if the UE receives SCI along with the reservation of the candidate resources including the single slot resource (R_{x,y}). The UE excludes the candidate single-slot resource if the RSRP measurement on the reservation signal by the UE is higher than a given RSRP threshold. The decision by the UE to exclude the single-slot resource also depends on a data priority level of the reserving SCI.

A blocking scenario is now described, corresponding to allocation of resources 214 by the transmitting UE when another UE has reserved resources 212, including slot 206. Generally, if the UE is operating on the unlicensed spectrum, and the inter-UE blocking consideration feature is enabled, the UE excludes any resources within a certain number A of slots before R_{x,y} are excluded from the set S_{A} of candidate slots. In some implementations, the value of A may be configured or preconfigured per resource pool of the UE. The configuration of the number A of slots to exclude is performed by the UE together with the enabling or disabling of the inter-UE blocking feature. In some implementations, the value of A is not directly a number of slots, but rather a time duration that can be used to calculate a number of slots (e.g., based on a frequency being used).

The number of slots A to exclude can depend on one or more of the following factors. The value of A may depend on a CAPC value of a given slot reservation from other UEs. The CAPC value is generally included in the SCI, either in stage 1 or stage 2. For a smaller CAPC value, a smaller value of A is used. In some implementations, for a relatively larger CAPC value, a relatively larger value of A is used. The values of the CAPC and the value of A can therefore be directly proportional. In some implementations, the relationship of the value of A to the CAPC value is non-linear. For example, if the value of p (which is the priority class, previously described) is 4, a largest value of A can be 9 milliseconds, or 9 slots in SCS=15 kilohertz (kHz), and 18 slots in SCS−30 kHz. In another example, when the value of p is 1, a largest value of A may be 1 slot. In another example, the value of A can depend on the CAPC value of the transmitting UE. If the CAPC value is larger, the value of A is larger. If the CAPC value is smaller, the value of A is smaller.

The value of A can depend on a priority value (e.g., prio_RX) of a reservation from other UEs and priority value (e.g., prio_TX) of the data of the transmitting UE. For example, if the value of prio_TX is smaller than the value of prio_RX, the transmitting UE has higher priority data than the other, reservation UE. In this scenario, the value of A is 0, because the potential blocking issue is not considered by transmitting UE during the resource allocation of the transmitting UE. Conversely, when a value of prio_TX is larger than the value of prio_RX, the transmitting UE has lower priority data than the data of the reservation UE. In this scenario, the value of A is determined based on the CAPC value of the other UEs, and the blocking issue is considered by the transmitting UE during resource allocation for the transmitting UE.

The value of A can depend on a LBT type for the reservation UE LBT operations. Generally, the LBT type information is included in the SCI (e.g., either in stage 1 or stage 2). The value of A can be a first value for a first type of LBT operations, and a second value for a second type of LBT operations. Generally, the first type of LBT operation (i.e., type 1 LBT) has the largest A value. Type 2a has the second largest A value. Type 2b has the third largest A value. Type 2c has the smallest A value (e.g., A=0).

The value of A is determined by the transmitting UE for UE resource allocation using one or more of the options described previously, either individually or in combination. For determination of the value of A, the CAPC value of the transmitting UE is passed from the higher layer of the transmitting UE to the physical layer of the transmitting UE.

A blocked scenario is now described, corresponding to allocation of resources 218 by the transmitting UE when another UE has reserved resources 216, including slot 208. In this case, the operation of the transmitting UE is on unlicensed spectrum and the inter-UE feature of “blocked” is enabled. In this case, any resources within a certain number B of slots after the reserved resources R_{x,y} 216 are excluded from the set S_{A} of candidate resources.

In some implementations, the value of B may be configured or preconfigured per resource pool of the UE. The configuration of the number B of slots to exclude is performed by the UE together with the enabling or disabling of the inter-UE blocking feature. In some implementations, the value of B is not directly a number of slots, but rather a time duration that can be used to calculate a number of slots (e.g., based on a frequency being used).

The number of slots B to exclude can depend on one or more of the following factors. The value of B may depend on a CAPC value (of the type 1 LBT) of a given slot reservation from the transmitting UE. For a smaller CAPC value, a smaller value of B is used. In some implementations, for a relatively larger CAPC value, a relatively larger value of B is used. The values of the CAPC and the value of B can therefore be directly proportional. In some implementations, the relationship of the value of B to the CAPC value is non-linear. For example, if the value of p (which is the priority class, previously described) is 4, a largest value of B can be 9 milliseconds, or 9 slots in SCS=15 kilohertz (kHz), and 18 slots in SCS=30 kHz. In another example, when the value of p is 1, a largest value of B may be 1 slot. In another example, the value of B can depend on the CAPC value of the other UE(s). The CAPC value is generally included in the SCI, either in stage 1 or stage 2. If the CAPC value of the other UE is larger, the value of B is larger. If the CAPC value of the other UE is smaller, the value of B is smaller.

The value of B can depend on a priority value (e.g., prio_RX) of a reservation from other UEs and priority value (e.g., prio_TX) of the data of the transmitting UE. For example, if the value of prio_TX is smaller than the value of prio_RX, the transmitting UE has higher priority data than the other, reservation UE. In this scenario, the value of B is 0, because the potential blocking issue is not considered by transmitting UE during the resource allocation of the transmitting UE. Conversely, when a value of prio-TX is larger than the value of prio_RX, the transmitting UE has lower priority data than the data of the reservation UE. In this scenario, the value of B is determined based on the CAPC value of the transmitting UE, and the blocking issue is considered by the transmitting UE during resource allocation for the transmitting UE.

The value of B can depend on a LBT type for the transmitting UE LBT operations. The value of B can be a first value for a first type of LBT operations, and a second value for a second type of LBT operations. For example, if a type 2A/2B LBT is to be used by the transmitting UE, then B is equal to 1 slot. If a type 2C LBT is to be used by the transmitting UE, then B is equal to 0 slots.

The value of B is determined by the transmitting UE for UE resource allocation using one or more of the options described previously, either individually or in combination. For determination of the value of B, the CAPC value of the transmitting UE is passed from the higher layer of the transmitting UE to the physical layer of the transmitting UE.

FIG. 2B shows an illustration of an example transmission timeline 200b for a UE (e.g., UE 102 of FIG. 1) for SL transmissions in the unlicensed spectrum for a partial slot transmission procedure. The transmitting UE is configured to allocate resources 262 within a slot 252 prior to another slot 254 that includes reserved resources 260 for another UE. An LBT time 256 is used by the other UE for channel access, and the transmitting UE's reserved resources 262 do not conflict with the other reserved resources 260, or interfere with the other UE's LBT operation time 256.

The UE uses a legacy resource selection as previously described. To avoid inter-UE blocking, if a selected resource is a slot 252 before the other UE's reserved resource 260, the CAPC index of the other UE is checked. If the other UE's CAPC index is within certain range, the UE determines a sensing duration of the other UE. For example, for a CAPC index of value 2, the LBT sensing duration is up to 15*9□s=135 μs, which is a 2 symbol duration in SCS=15 kHz, or 4 a symbol duration in SCS=30 kHz.

In some implementations, if the data priority of other UE is higher than a threshold, the transmitting UE only applies the partial slot transmissions. In some implementations, if the data priority of the transmitting UE is lower than a threshold, the transmitting UE only applies the partial slot transmissions. The last few symbols, besides a gap symbol, are left un-transmitted. The UE-1's LBT idle duration 256 is then satisfied. This process is generally applicable to slots with PSFCH. Generally, the SCI for this transmission indicates a partial slot transmission.

Alternatively, or in addition, the transmitting UE can perform resource selection with a lower possibility on the neighbor slot to existing reserved resources. The physical layer of the transmitting UE identifies available resources. The MAC layer of the transmitting UE selects the resources in a neighbor slot 252 to the existing reservation 260 with a relatively lower probability. The MAC layer selects resources that are not in a neighbor slot 252 to any existing reservation 260 with a relatively higher probability.

FIG. 3 shows an illustration of an example transmission timeline 300 for a UE (e.g., UE 102 of FIG. 1) for SL transmissions. The UE is configured to perform SL resource allocation based on timeline restrictions in resource allocation. The transmitting UE allocates resources 356a-b near or next to a slot 350 that is already allocated for the UE SL operations. In this example, the UE already has channel access for a given slot 350. The resources immediately prior 356a and subsequent to 356b this allocated slot 350 are prioritized for resource allocation for that UE. For example, the UE can prioritize allocation of the channel for resources 356a just prior to an existing allocated slot 350. The UE can then perform type 1 LBT operations once, before the newly allocated resources, for both the newly allocated resources 356a and the previously allocated slot 350, as the UE need only access the channel once for both sets resources. Additionally, the UE can select resources 356b just after the previously allocated slot 350. The UE need only perform type 2 LBT operations 352a-b once for both resources 350, 356b to access the channel. Each of these approaches simplifies channel access for the UE and increases efficiency of channel access by the UE for NR-U SL operations.

The UE can perform resource selection for NR-U SL while considering channel occupancy time (COT) as a factor. The UE prioritizes resources 356a-b in neighbor slots of existing reserved or selected resources 354. The UE maintains an existing COT duration and avoids type 1 LBT operations for the transmission on the existing reserved resource 350 or for the transmission on the new reserved resources 356a or 356b. As with the prior example, the prioritization of these resources 356a-b can be enabled or disabled per resource pool, either by pre-configuration or during configuration of the resource allocation. In some implementations, the COT-based resources selection can depend on the data priority or CAPC index of the data. For example, for high priority data, the COT-based resource allocation by the UE may be enabled. In another example, for low priority data, the COT-based resource allocation by the UE may be disabled. Similarly, for a small CAPC index, the UE can disable the COT-based resource allocation process. In another example, the UE can disable the COT-based resource allocation process for a large CAPC index.

A physical layer of the transmitting UE reports a single candidate resource S_{A} set with prioritized resources 356a-b as neighbor slots to existing reserved or selected resources 354. For example, prior to determination of the resource selection window by the transmitting UE, the UE higher layer provides the existing reservation information to the physical layer for the resource selection procedure previously described. The reporting is based on the same source and destination ID of the existing reserved or selected resources 354 and new resource reservation 356a-b. Additionally, the feature is based on there being a same CAPC index of the existing reserved or selected resources 354 and new resource reservation 356a-b. Additionally, the feature is based on there being a same priority of the existing reserved or selected resources 354 and new resource reservation 356a-b.

The UE obtains the RSRP values as previously described for the resource selection procedure. The UE obtains initial RSRP threshold values (“sl-Thres-RSRP-List”). Generally, the UE applies two sets of initial RSRP threshold values. A first set is for the non-contiguous resources (not shown) to the existing reserved or selected resources 354. A second set is for the resources 356a-b neighbor slots of the existing reserved or selected resources 354. Generally, set 2 has a larger initial RSRP threshold values relative to set 1 for the same data priority values prior_{Tx} and prio_{Rx}.

For the resource selection procedure, the UE is configured to increase 3 dB on RSRP threshold if the number of resources in S_{A} is smaller than X*Mₜₒₜₐₗ. In this example, the UE increases 3 dB on RSRP threshold for set 1. The UE increases (dB on the RSRP threshold for set 2 and goes to Step 1.3. Otherwise, the UE reports the candidate set S_{A} of resources to the higher layer. In some implementations, the value of C can be larger than 3. Generally, the value of C can be configured or pre-configured per resource pool of the UE, or pre-defined.

The UE can alternatively perform resource selection as described below. The physical layer of the UE reports two candidate sets S_{A} of resources, including S_{A-1}, S_{A-2} sets. In a first example, the UE uses two separate procedures to generate the candidate resource sets S_{A-1} set and S_{A-2}. The UE generates the S_{A-1} set using legacy processes described in the 3GPP TS 38.213. The initial S_{A-1} set can be the set to exclude the initial candidate slots for the second candidate set S_{A-2}. The UE generates the S_{A-2} set by setting the initial candidate slot to be a neighbor slot to an existing reservation. This process for generation of the second set is similar to a partial sensing process in which candidate slots are predetermined. The generation of the candidate slots based on the existing allocated resources is called an in-COT resource selection by the UE.

To perform the in-COT resource selection, the UE performs the following operations. Prior to determining the resource selection window, the UE's higher layer provides existing reservation information to the physical layer for resource selection. The UE has a same source and destination identifier for the existing reserved resource and the new resource reservation. The UE has a same CAPC index for each of the existing reserved resource and the new resource reservation. The UE has a same priority for the existing reserved resource and the new resource reservation.

The UE is configured to obtain the initial RSRP values, as previously described. The UE obtains the initial RSRP threshold values (“sl-Thres-RSRP-List”). In this example, the UE can use same or different initial RSRP threshold values for generating the candidate resource sets S_{A-1} and S_{A-2}. When the UE is recalculating the RSRP threshold (if needed), a same or different “sl-TxPercentageList” may be used for generating S_{A-1} and S_{A-2} sets.

Alternatively, or in addition to previous examples, the UE can perform resource selection using the MAC layer. For this example, the MAC layer of the UE is configured to select resources in the reported candidate resources. The UE MAC layer first determines a subset of the candidate set S_{A} including neighbor slots (e.g., 356a-b) of the existing reservation slots (e.g., slot 350). In this example, if the number of resources in this subset is larger than a threshold, the UE randomly selects resources within the subset. If the number of resources in the subset is smaller than a threshold number (e.g., ˜10), the UE randomly select resources within the reported candidate set S_{A}.

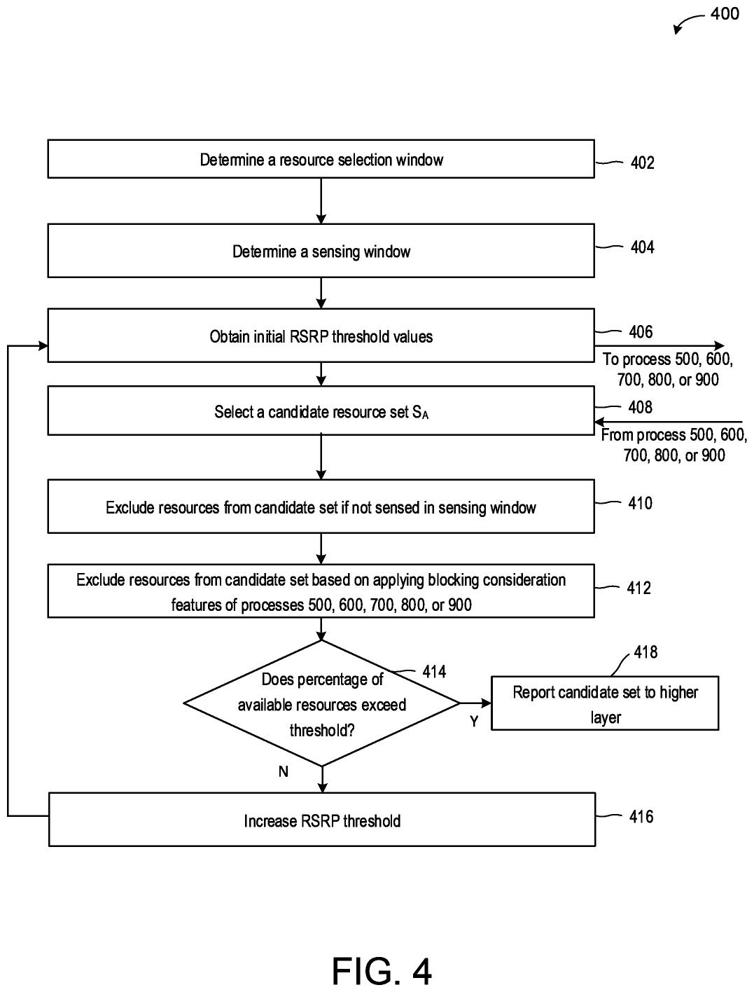

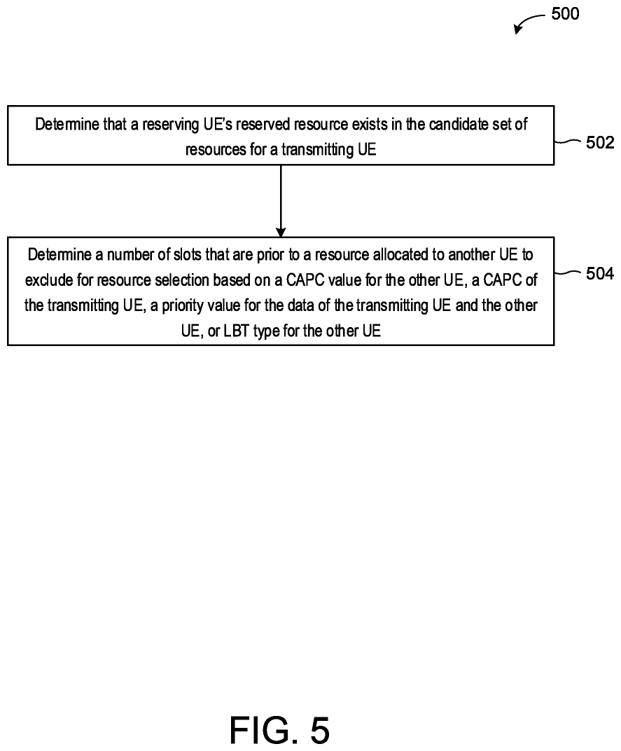

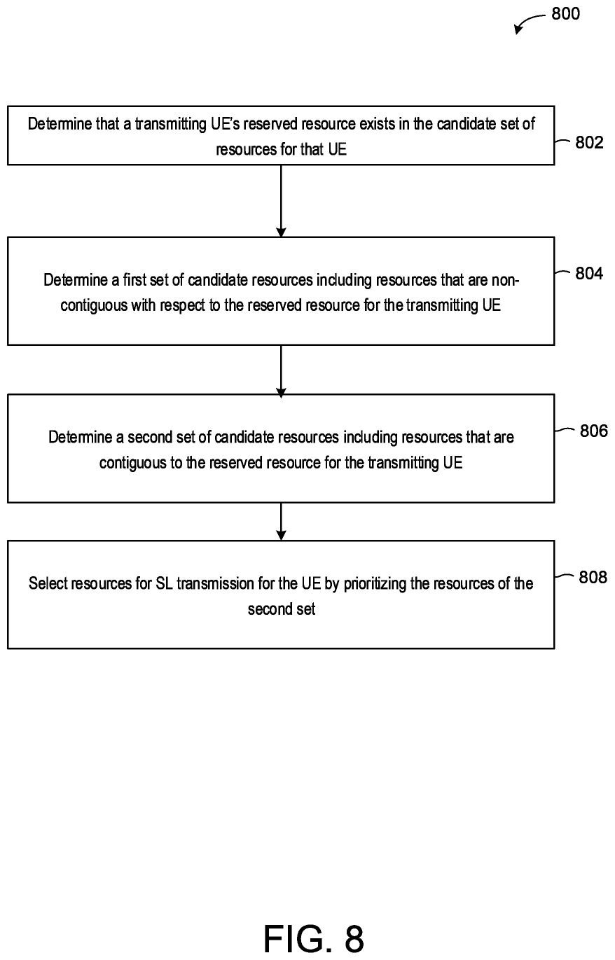

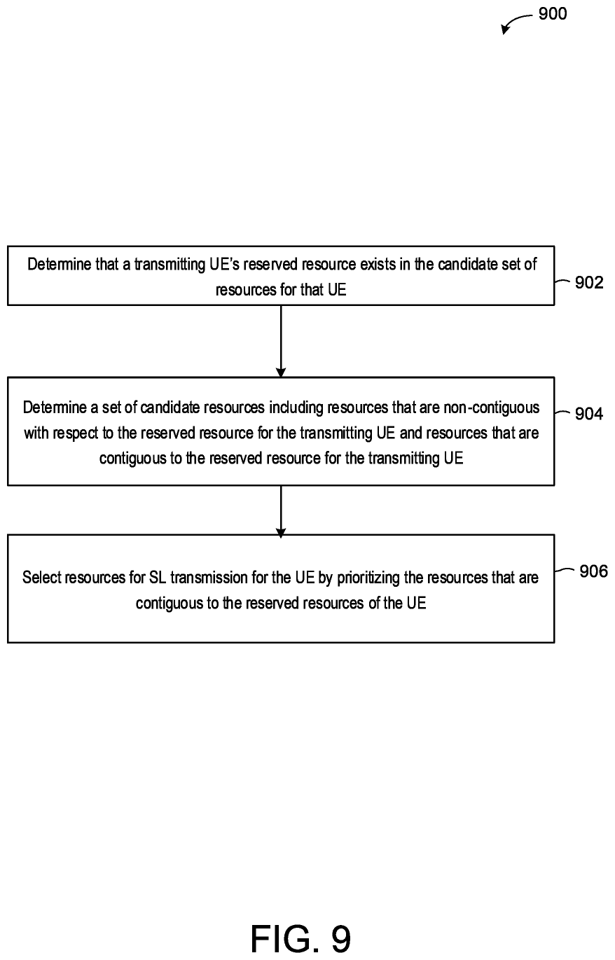

FIG. 4 shows an example process 400 performed by a UE for resource allocation for sidelink transmissions in unlicensed spectrum for mode 2. The process 400 may be performed by a UE, such as UE 102 of FIG. 1. Process 400 includes a resource selection procedure based on steps described for NR V2X R. 16 in which LBT operations are considered, as previously described. The UE determines (402) a resource selection window (n+T1, n+T2), with total number of candidate resources. The UE determines (404) a sensing window. The UE obtains (406) initial RSRP threshold values. The UE selects (408) a candidate resource set to be all the resources in the resource selection window. The UE excludes (410) candidate resources from the candidate set if the UE did not sense them in sensing window with configured resource reservation periods before the candidate slot. The UE excludes (412) candidate resources from the candidate set by applying the blocking or blocked consideration features of processes 500, 600, and 700 as subsequently described in relation to FIGS. 5, 6, and 7, respectively. The UE excludes (412) candidate resources from the candidate set by applying the type 1 LBT reduction features of processes 800, 900 as subsequently described in relation to FIGS. 8 and 9, respectively. The resources are excluded if the UE receives a SCI with reservation of the candidate resources. The resources are excluded if the RSRP measurement is higher than the RSRP thresholds, depending also on data priority level of the reserving SCI. If the number of resources in the candidate resource set (after exclusions) is smaller than a threshold percentage of the total available resources in a comparison (414), the UE increases (416) the RSRP threshold. Otherwise, the UE reports (418) the candidate set to the higher layer.

FIG. 5 shows an example process 500 performed by a UE for resource allocation for sidelink transmissions in unlicensed spectrum for mode 2. The process 500 may be performed by a UE, such as UE 102 of FIG. 1. In an example, the process 500 of FIG. 5 is discussed with respect to FIG. 2A.

The process 500 includes determining (502) that a reserving UE's reserved resource exists in the candidate set of resources for a transmitting UE. The process 500 includes determining (504) a number of slots that are prior to a resource allocated to another UE to exclude for resource selection based on a CAPC value for the other UE, a CAPC of the transmitting UE, a priority value for the data of the transmitting UE and the other UE, or LBT type for the other UE. As previously described, for larger CAPC values, a larger number of slots are excluded from the candidate set of resources. The exclusion of the slots prior to the reserved resource and designated by this number is dynamically considered. As previously described, if the priority for the data of the transmitting UE is lower than the data of the other UE that has reserved the resources, the exclusion of the slots designated by the number is considered. If the transmitting UE has higher priority data than the data of the UE that has reserved the resources, the exclusion of the slots designated by the number is not considered. In some implementations, the LBT type of the reserving UE is considered for the number of slots excluded from the candidate set for the transmitting UE.

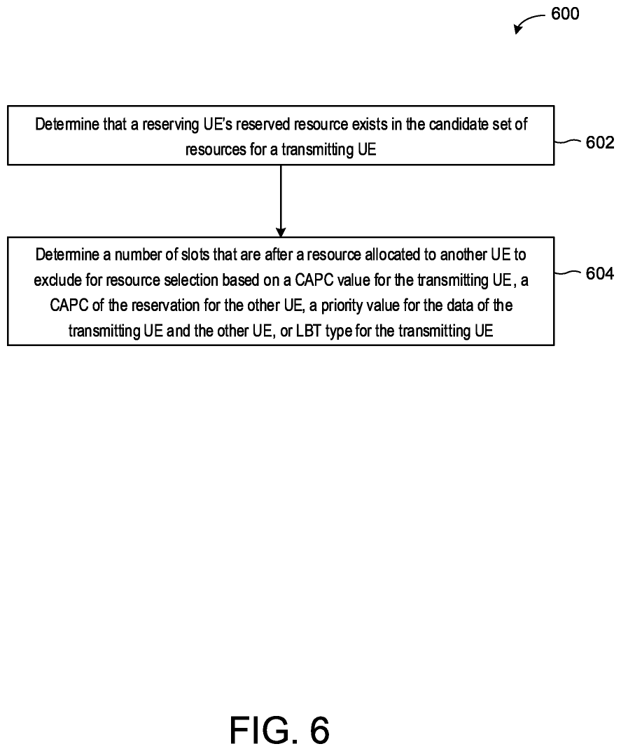

FIG. 6 shows an example process 600 performed by a UE for resource allocation for sidelink transmissions in unlicensed spectrum for mode 2. The process 600 may be performed by a UE, such as UE 102 of FIG. 1. In an example, the process 600 of FIG. 6 is discussed with respect to FIG. 2A.

The process 600 includes determining (602) that a reserving UE's reserved resource exists in the candidate set of resources for a transmitting UE. The process includes determining (604) a number of slots that are after a resource allocated to the other, reserving UE to exclude for resource selection based on a CAPC value for the transmitting UE, a CAPC of the reservation for the other UE, a priority value for the data of the transmitting UE and the other UE, or LBT type for the transmitting UE. The exclusion of the slots after the reserved resource and designated by this number is dynamically considered. As previously described, if the priority for the data of the transmitting UE is lower than the data of the other UE that has reserved the resources, the exclusion of the slots designated by the number is considered. If the transmitting UE has higher priority data than the data of the UE that has reserved the resources, the exclusion of the slots designated by the number is not considered. In some implementations, the LBT type of the transmitting UE is considered for the number of slots excluded from the candidate set for the transmitting UE. In some implementations, if the LBT operations are type 2A/2B, the number of slots excluded from the candidate set is 1 slot. In some implementations, if the LBT operations are type 2C, the number of slots excluded from the candidate set is 0 slots. The LBT type and CAPC value of the transmitting UE are passed from the higher layer of transmitting UE to the physical layer of the transmitting UE.

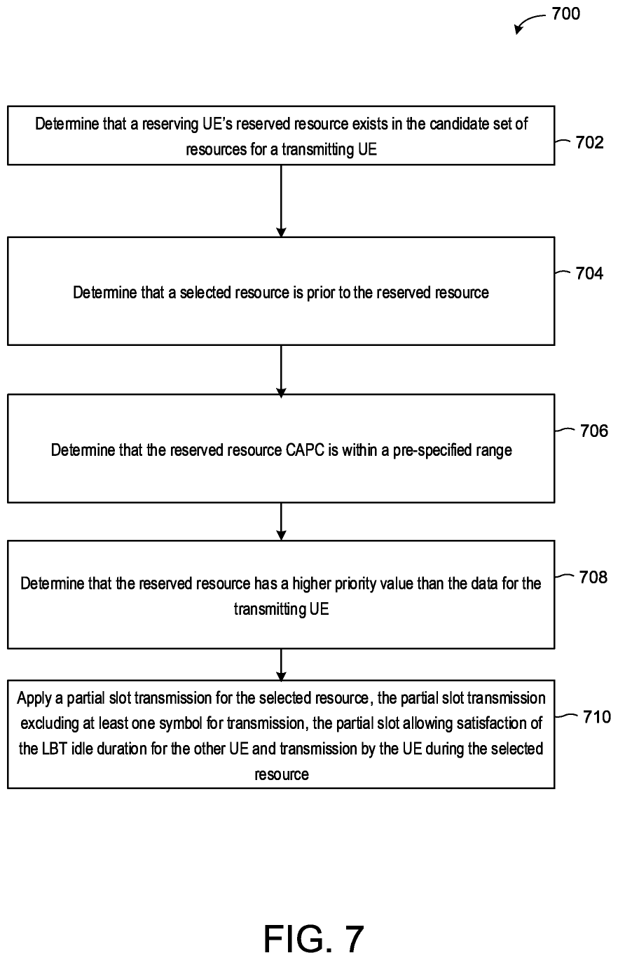

FIG. 7 shows an example process 700 performed by a UE for resource allocation for sidelink transmissions in unlicensed spectrum for mode 2. The process 700 may be performed by a UE, such as UE 102 of FIG. 1. In an example, the process 700 of FIG. 7 is discussed with respect to FIG. 3.

The process 700 includes determining (702) that a reserving UE's reserved resource exists in the candidate set of resources for a transmitting UE. The process 700 includes determining (704) that a selected resource is prior to the reserved resource. The process 700 includes determining (706) that the reserved resource CAPC is within a pre-specified range. For example, for the CAPC index 2, the LBT sensing duration is up to 15*9 μs=135 μs, which is 2 symbol duration in SCS=15 kHz or 4 symbol duration in SCS=30 kHz. The determination of whether a partial transmission is possible is based on this determined duration. The process 700 includes determining (708) that the reserved resource has a higher priority value than the data for the transmitting UE. The process 700 includes applying (710) a partial slot transmission to for the selected resource, the partial slot transmission excluding at least one symbol for transmission, the partial slot allowing satisfaction of the LBT idle duration for the other UE.

FIG. 8 shows an example process 800 performed by a UE for resource allocation for sidelink transmissions in unlicensed spectrum for mode 2. The process 800 may be performed by a UE, such as UE 102 of FIG. 1. In an example, the process 800 of FIG. 8 is discussed with respect to FIG. 2B.

The process 800 includes determining (802) that a transmitting UE's reserved resource exists in the candidate set of resources. The process 800 includes determining (804) a first set of candidate resources including resources that are non-contiguous with respect to the reserved resource for the transmitting UE. The process 800 includes determining (806) a second set of candidate resources including resources that are contiguous to the reserved resource for the transmitting UE. The process 800 includes selecting (808) resources for SL transmission for the UE by prioritizing the resources of the second set. Generally, the process 800 is performed when there is a same source and destination identifier for an existing reserved resource and new resource reservation. The process 800 is performed when there is a same CAPC index of the existing reserved resource and new resource reservation. The process 800 is performed when there is a same priority of the existing reserved resource and new resource reservation.

In some implementations, the process 800 can be enabled or disabled (e.g., during execution of process 400 of FIG. 4) based on the data priority or CAPC index of the data for transmission. For example, for high priority data, process 800 may be enabled. For example, for low priority data, process 800 may be disabled. For example, for a small CAPC index, process 800 may be enabled. For a large CAPC index, process 800 may be disabled during execution of process 400.

In some implementations, process 800 includes obtaining initial RSRP threshold values (“sl-Thres-RSRP-List”), where two sets of initial RSRP threshold values are applied. The first set of RSRP thresholds are applied for the non-contiguous resources to the existing reserved resources. The second set of RSRP thresholds are applied for the resources in a neighbor slot of the existing reserved resources. The second set of RSRP threshold values has the larger initial RSRP threshold values than relative to the first set for the same data priority values. When the percentage of excluded resources exceeds a threshold value, an increased threshold value is set for the RSRP threshold values for the second set.

FIG. 9 shows an example process 900 performed by a UE for resource allocation for sidelink transmissions in unlicensed spectrum for mode 2. The process 900 may be performed by a UE, such as UE 102 of FIG. 1. In an example, the process 900 of FIG. 8 is discussed with respect to FIG. 2B.

The process 900 includes determining (902) that a transmitting UE's reserved resource exists in the candidate set of resources. The process 900 includes determining (904) a set of candidate resources including resources that are non-contiguous with respect to the reserved resource for the transmitting UE and resources that are contiguous to the reserved resource for the transmitting UE. The process 900 includes selecting (906) resources for SL transmission for the UE by prioritizing the resources that are contiguous to the reserved resources of the UE. Generally, the first set of candidate resources is generated according to process 400. The second set of candidate resources is generated to include only resources that are contiguous to the reserved slots.

In some implementations, the transmitting UE's higher layer provides the existing reservation information to the physical layer for its resource selection procedure. There is the same source and destination ID of the existing reserved resource and new resource reservation. There is the same CAPC index of the existing reserved resource and new resource reservation. There is the same priority of the existing reserved resource and new resource reservation.

In some implementations, the process includes obtaining initial RSRP threshold values (“sl-Thres-RSRP-List”) for each of the first and second sets of candidate resources. In some implementations, the same RSRP threshold values are used for each of the first set and the second set. In some implementations, different RSRP values are used for each of the first set and the second set. In some implementations, a percentage value for available candidate slots of the total is used to determine whether the RSRP threshold values are changed, as previously described. In some implementations, the same threshold percentage value is used for each of the first set and the second set. In some implementations, a different threshold percentage value is used for each of the first set and the second set.

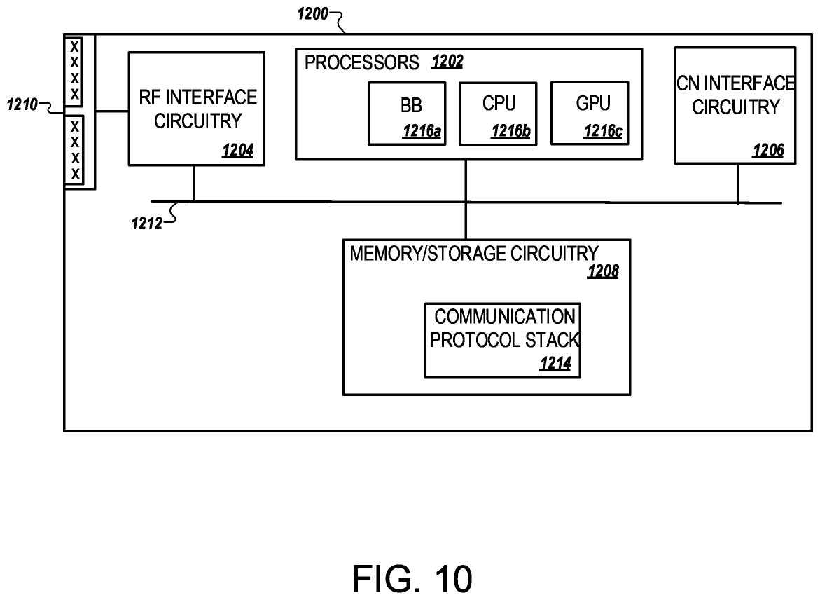

FIG. 10 illustrates an access node 1200 (e.g., a base station or gNB), in accordance with some embodiments. The access node 1200 may be similar to and substantially interchangeable with base station 104. The access node 1200 may include processors 1202, RF interface circuitry 1204, core network (CN) interface circuitry 1206, memory/storage circuitry 1208, and antenna structure 1210.

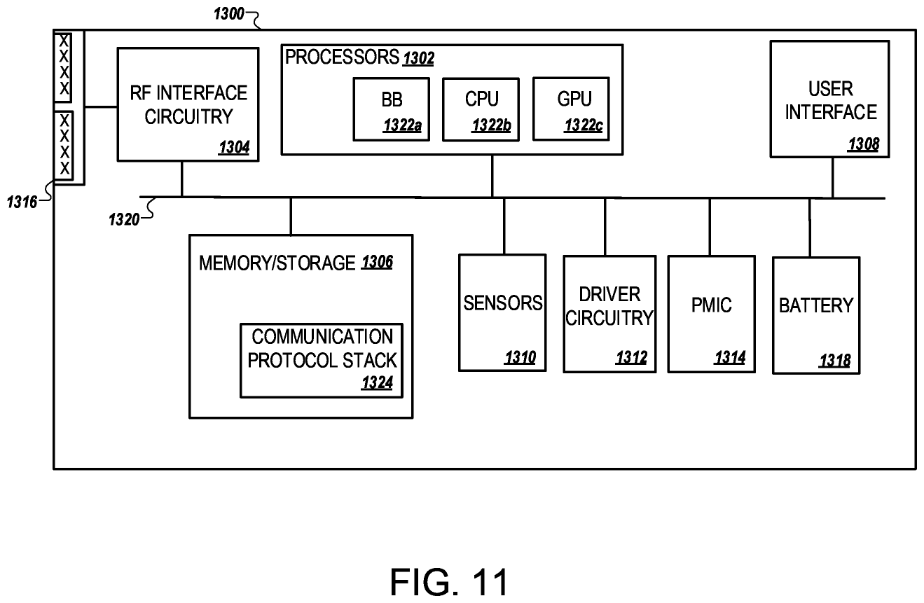

The components of the access node 1200 may be coupled with various other components over one or more interconnects 1212. The processors 1202, RF interface circuitry 1204, memory/storage circuitry 1208 (including communication protocol stack 1214), antenna structure 1210, and interconnects 1212 may be similar to like-named elements shown and described with respect to FIG. 11. For example, the processors 1202 may include processor circuitry such as, for example, baseband processor circuitry (BB) 1216A, central processor unit circuitry (CPU) 1216B, and graphics processor unit circuitry (GPU) 1216C.

The CN interface circuitry 1206 may provide connectivity to a core network, for example, a 5th Generation Core network (5GC) using a 5GC-compatible network interface protocol such as carrier Ethernet protocols, or some other suitable protocol. Network connectivity may be provided to/from the access node 1200 via a fiber optic or wireless backhaul. The CN interface circuitry 1206 may include one or more dedicated processors or FPGAs to communicate using one or more of the aforementioned protocols. In some implementations, the CN interface circuitry 1206 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1200 that operates in an NR or 5G system (for example, a gNB), and the term “E-UTRAN node” or the like may refer to an access node 1200 that operates in an LTE or 4G system (e.g., an eNB). According to various embodiments, the access node 1200 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some embodiments, all or parts of the access node 1200 may be implemented as one or more software entities running on server computers as part of a virtual network, which may be referred to as a CRAN and/or a virtual baseband unit pool (vBBUP). In these embodiments, the CRAN or vBBUP may implement a RAN function split, such as a PDCP split wherein RRC and PDCP layers are operated by the CRAN/vBBUP and other L2 protocol entities are operated by the access node 1200; a MAC/PHY split wherein RRC, PDCP, RLC, and MAC layers are operated by the CRAN/vBBUP and the PHY layer is operated by the access node 1200; or a “lower PHY” split wherein RRC, PDCP, RLC, MAC layers and upper portions of the PHY layer are operated by the CRAN/vBBUP and lower portions of the PHY layer are operated by the access node 1200.

In V2X scenarios, the access node 1200 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

FIG. 11 illustrates a UE 1300, in accordance with some embodiments. The UE 1300 may be similar to and substantially interchangeable with UE 102 of FIG. 1. The UE 1300 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 1300 may include processors 1302, RF interface circuitry 1304, memory/storage 1306, user interface 1308, sensors 1310, driver circuitry 1312, power management integrated circuit (PMIC) 1314, antenna structure 1316, and battery 1318. The components of the UE 1300 may be implemented as integrated circuits (ICs), portions thereof, discrete electronic devices, or other modules, logic, hardware, software, firmware, or a combination thereof. The block diagram of FIG. 11 is intended to show a high-level view of some of the components of the UE 1300. However, some of the components shown may be omitted, additional components may be present, and different arrangement of the components shown may occur in other implementations.

The components of the UE 1300 may be coupled with various other components over one or more interconnects 1320, which may represent any type of interface, input/output, bus (local, system, or expansion), transmission line, trace, optical connection, etc. that allows various circuit components (on common or different chips or chipsets) to interact with one another.

The processors 1302 may include processor circuitry such as, for example, baseband processor circuitry (BB) 1322A, central processor unit circuitry (CPU) 1322B, and graphics processor unit circuitry (GPU) 1322C. The processors 1302 may include any type of circuitry or processor circuitry that executes or otherwise operates computer-executable instructions, such as program code, software modules, or functional processes from memory/storage 1306 to cause the UE 1300 to perform operations as described herein.

In some embodiments, the baseband processor circuitry 1322A may access a communication protocol stack 1324 in the memory/storage 1306 to communicate over a 3GPP compatible network. In general, the baseband processor circuitry 1322A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1304. The baseband processor circuitry 1322A may generate or process baseband signals or waveforms that carry information in 3GPP-compatible networks. In some embodiments, the waveforms for NR may be based cyclic prefix OFDM “CP-OFDM” in the uplink or downlink, and discrete Fourier transform spread OFDM “DFT-S-OFDM” in the uplink.

The memory/storage 1306 may include one or more non-transitory, computer-readable media that includes instructions (for example, communication protocol stack 1324) that may be executed by one or more of the processors 1302 to cause the UE 1300 to perform various operations described herein. The memory/storage 1306 include any type of volatile or non-volatile memory that may be distributed throughout the UE 1300. In some embodiments, some of the memory/storage 1306 may be located on the processors 1302 themselves (for example, L1 and L2 cache), while other memory/storage 1306 is external to the processors 1302 but accessible thereto via a memory interface. The memory/storage 1306 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1304 may include transceiver circuitry and radio frequency front module (RFEM) that allows the UE 1300 to communicate with other devices over a radio access network. The RF interface circuitry 1304 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1316 and proceed to filter and amplify (with a low-noise amplifier) the signal. The signal may be provided to a receiver of the transceiver that downconverts the RF signal into a baseband signal that is provided to the baseband processor of the processors 1302.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1316.

In various embodiments, the RF interface circuitry 1304 may be configured to transmit/receive signals in a manner compatible with NR access technologies.

The antenna 1316 may include antenna elements to convert electrical signals into radio waves to travel through the air and to convert received radio waves into electrical signals. The antenna elements may be arranged into one or more antenna panels. The antenna 1316 may have antenna panels that are omnidirectional, directional, or a combination thereof to enable beamforming and multiple input, multiple output communications. The antenna 1316 may include microstrip antennas, printed antennas fabricated on the surface of one or more printed circuit boards, patch antennas, phased array antennas, etc. The antenna 1316 may have one or more panels designed for specific frequency bands including bands in FRI or FR2.

The user interface 1308 includes various input/output (I/O) devices designed to enable user interaction with the UE 1300. The user interface 1308 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1300.

The sensors 1310 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1312 may include software and hardware elements that operate to control particular devices that are embedded in the UE 1300, attached to the UE 1300, or otherwise communicatively coupled with the UE 1300. The driver circuitry 1312 may include individual drivers allowing other components to interact with or control various input/output (I/O) devices that may be present within, or connected to, the UE 1300. For example, driver circuitry 1312 may include a display driver to control and allow access to a display device, a touchscreen driver to control and allow access to a touchscreen interface, sensor drivers to obtain sensor readings of sensor circuitry 1328 and control and allow access to sensor circuitry 1328, drivers to obtain actuator positions of electro-mechanic components or control and allow access to the electro-mechanic components, a camera driver to control and allow access to an embedded image capture device, audio drivers to control and allow access to one or more audio devices.

The PMIC 1314 may manage power provided to various components of the UE 1300. In particular, with respect to the processors 1302, the PMIC 1314 may control power-source selection, voltage scaling, battery charging, or DC-to-DC conversion.

In some embodiments, the PMIC 1314 may control, or otherwise be part of, various power saving mechanisms of the UE 1300 including DRX as discussed herein. A battery 1318 may power the UE 1300, although in some examples the UE 1300 may be mounted deployed in a fixed location, and may have a power supply coupled to an electrical grid. The battery 1318 may be a lithium ion battery, a metal-air battery, such as a zinc-air battery, an aluminum-air battery, a lithium-air battery, and the like. In some implementations, such as in vehicle-based applications, the battery 1318 may be a typical lead-acid automotive battery.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes a method having operations including a method for performing a sidelink (SL) communication in an unlicensed spectrum. The method includes determining a resource selection window for a user equipment (UE), the resource selection window including channel resources for a SL transmission by the UE. The method includes selecting a set of candidate resources in the resource selection window. The method includes excluding one or more resources from the set of candidate resources. The excluding includes determining that a reserved resource of another UE exists in the candidate set of resources. The excluding includes determining a number of slots that are prior to the reserved resource for the other UE to exclude from the set of candidate resources. The excluding includes excluding one or more slots from the set of candidate resources based on the number of slots. The method includes generating a resulting candidate set based on the excluding. The method includes generating a report of the resulting candidate set, or selecting a resource from the resulting candidate set.

Example 2 includes the method of example 1, wherein the number of slots is based on a channel access priority class (CAPC) value associated with a transmission of the UE, the CAPC value being included in sidelink control information of the UE.

Example 3 includes the methods of examples 1-2, wherein the number of slots is based on a channel access priority class (CAPC) value associated with the reserved resource of the other UE, the CAPC value being included in sidelink control information of the other UE.

Example 4 includes the methods of examples 1-3, wherein the number of slots is proportionally related to the CAPC value.

Example 5 includes the methods of examples 1-4, wherein the number of slots is a function of a sub-carrier spacing and the CAPC value.

Example 6 includes the methods of examples 1-5, wherein the number of slots is based on a listen before talk (LBT) type associated with the other UE, wherein the LBT type is specified in sidelink control information of the other UE.

Example 7 includes a method for performing a sidelink (SL) communication in an unlicensed spectrum. The method includes determining a resource selection window for a user equipment (UE), the resource selection window including channel resources for a SL transmission by the UE. The method includes selecting a set of candidate resources in the resource selection window. The method includes excluding one or more resources from the set of candidate resources, the excluding comprising determining that a reserved resource of another UE exists in the candidate set of resources. The excluding includes determining a number of slots that are after the reserved resource for the other UE to exclude from the set of candidate resources. The excluding includes excluding one or more slots from the set of candidate resources based on the number of slots. The method includes generating a resulting candidate set based on the excluding. The method includes generating a report of the resulting candidate set, or selecting a resource from the resulting candidate set.

Example 8 includes the method of example 7, wherein the number of slots is based on a channel access priority class (CAPC) value associated with the UE, the CAPC value being included in sidelink control information of the UE.

Example 9 includes the methods of examples 7-8, wherein the number of slots is based on a channel access priority class (CAPC) value associated with the reserved resource of the other UE, the CAPC value being included in sidelink control information of the other UE.

Example 10 includes the methods of examples 7-9, wherein the number of slots is proportionally related to the CAPC value.

Example 11 includes the methods of examples 7-10, wherein the number of slots is a function of a sub-carrier spacing and the CAPC value.

Example 12 includes the methods of examples 7-11, wherein the number of slots is based on a listen before talk (LBT) type associated with the UE, wherein the LBT type is specified in sidelink control information of the other UE.

Example 13 includes the methods of examples 7-12, wherein the number of slots is 1 if the LBT type is type 2A or type 2B, and wherein the number of slots is 0 if the LBT type is type 2C.

Example 14 includes a method for performing a sidelink (SL) communication. The method includes determining a resource selection window for a user equipment (UE), the resource selection window including channel resources for a SL transmission by the UE. The method includes selecting a set of candidate resources in the resource selection window. The method includes determining that a reserved resource of another UE exists in the candidate set of resources. The method includes determining that a selected resource, of the set of candidate resources, is contiguous and prior to the reserved resource. The method includes applying a partial slot transmission for the selected resource, the partial slot transmission excluding at least one symbol that is planned for transmission in the selected resource.

Example 15 includes the method of example 14, the method further including determining that a CAPC value for the reserved resource is within a pre-specified range of values, wherein the applying the partial slot transmission is based on the determining.

Example 16 includes the methods of examples 14-15, the method further including determining that the reserved resource has a higher priority value than another priority value for the UE, wherein the applying the partial slot transmission is based on the determining.

Example 17 includes the methods of examples 14-16, the method further including, wherein the partial slot transmission enables satisfaction of a LBT idle duration for the other UE and transmission by the UE during the selected resource.

Example 18 includes a method for performing a sidelink (SL) communication, the method including determining a resource selection window for a user equipment (UE), the resource selection window including channel resources for a SL transmission by the UE. The method includes selecting a set of candidate resources in the resource selection window. The method includes determining that a reserved or selected resource for the UE exists in the set of candidate resources. The method includes determining a first subset of candidate resources including resources that are non-contiguous with respect to the reserved resource and a second subset of candidate resources including resources that are contiguous to the reserved resource. The method includes selecting a resource for SL transmission for the UE, wherein the second subset of candidate resources are prioritized relative to the first subset during the selection.

Example 19 includes the method of example 18, wherein the reserved or selected resource and the selected resource have a same source identifier and a same destination identifier.

Example 20 includes the methods of examples 18-19, wherein the reserved or selected resource and the selected resource are associated with a same CAPC value.

Example 21 may include an apparatus comprising means to perform one or more elements of a method described in or related to any of examples 1-20, or any other method or process described herein.

Example 22 may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Example 23 may include an apparatus comprising logic, modules, or circuitry to perform one or more elements of a method described in or related to any of examples 1-20, or any other method or process described herein.

Example 24 may include a method, technique, or process as described in or related to any of examples 1-20, or portions or parts thereof.

Example 25 may include an apparatus comprising: one or more processors and one or more computer-readable media comprising instructions that, when executed by the one or more processors, cause the one or more processors to perform the method, techniques, or process as described in or related to any of examples 1-20, or portions thereof.

Example 26 may include a signal as described in or related to any of examples 1-26, or portions or parts thereof.

Example 27 may include a datagram, packet, frame, segment, protocol data unit (PDU), or message as described in or related to any of examples 1-26, or portions or parts thereof, or otherwise described in the present disclosure.

Example 28 may include a signal encoded with data as described in or related to any of examples 1-26, or portions or parts thereof, or otherwise described in the present disclosure.

Example 29 may include a signal encoded with a datagram, packet, frame, segment, protocol data unit (PDU), or message as described in or related to any of examples 1-26, or portions or parts thereof, or otherwise described in the present disclosure.

Example 30 may include an electromagnetic signal carrying computer-readable instructions, wherein execution of the computer-readable instructions by one or more processors is to cause the one or more processors to perform the method, techniques, or process as described in or related to any of examples 1-26, or portions thereof.

Example 31 may include a computer program comprising instructions, wherein execution of the program by a processing element is to cause the processing element to carry out the method, techniques, or process as described in or related to any of examples 1-26, or portions thereof.

Example 32 may include a signal in a wireless network as shown and described herein.

Example 33 may include a method of communicating in a wireless network as shown and described herein.

Example 34 may include a system for providing wireless communication as shown and described herein.

Example 35 may include a device for providing wireless communication as shown and described herein.

Example 36 may include an apparatus according to any of any one of examples 1-26, wherein the apparatus or any portion thereof is implemented in or by a user equipment (UE).

Example 37 may include a method according to any of any one of examples 1-26, wherein the method or any portion thereof is implemented in or by a user equipment (UE).

Example 38 may include an apparatus according to any of any one of examples 1-26, wherein the apparatus or any portion thereof is implemented in or by a base station (BS).

Example 39 may include a method according to any of any one of examples 1-26, wherein the method or any portion thereof is implemented in or by a base station (BS).

Example 40 may include an apparatus according to any of any one of examples 1-26, wherein the apparatus or any portion thereof is implemented in or by a network element.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. One or more processors configured to execute instructions stored in memory to perform operations comprising:
determining a resource selection window for a user equipment (UE), the resource selection window including channel resources for a SL transmission by the UE;
selecting a set of candidate resources in the resource selection window;
excluding one or more resources from the set of candidate resources, the excluding comprising:
determining that a reserved resource of another UE exists in the candidate set of resources;
determining a first number of slots that are prior to the reserved resource for the other UE to exclude from the set of candidate resources or determining a second number of slots that are after the reserved resource for the other UE to exclude from the set of candidate resources; and
excluding one or more slots from the set of candidate resources based on the first number of slots or the second number of slots;
generating a resulting candidate set based on the excluding; and
selecting a resource from the resulting candidate set.

2. The one or more processors of claim 1, wherein the first number of slots is based on a channel access priority class (CAPC) value associated with a transmission of the UE, the CAPC value being included in sidelink control information of the UE.

3. The one or more processors of claim 1, wherein the first number of slots is based on a channel access priority class (CAPC) value associated with the reserved resource of the other UE, the CAPC value being included in sidelink control information of the other UE.

4. The one or more processors of claim 3, wherein the first number of slots is proportionally related to the CAPC value.

5. The one or more processors of claim 3, wherein the first number of slots is a function of a sub-carrier spacing and the CAPC value.

6. The one or more processors of claim 1, wherein the first number of slots is based on a listen before talk (LBT) type associated with the other UE, wherein the LBT type is specified in sidelink control information of the other UE.

7. (canceled)

8. The one or more processors of claim 1, wherein the second number of slots is based on a channel access priority class (CAPC) value associated with the UE, the CAPC value being included in sidelink control information of the UE.

9. The one or more processors of claim 1, wherein the second number of slots is based on a channel access priority class (CAPC) value associated with the reserved resource of the other UE, the CAPC value being included in sidelink control information of the other UE.

10. The one or more processors of claim 9, wherein the second number of slots is proportionally related to the CAPC value.

11. The one or more processors of claim 9, wherein the second number of slots is a function of a sub-carrier spacing and the CAPC value.

12. The one or more processors of claim 1, wherein the second number of slots is based on a listen before talk (LBT) type associated with the UE, wherein the LBT type is specified in sidelink control information of the other UE.

13. The one or more processors of claim 12, wherein the second number of slots is 1 if the LBT type is type 2A or type 2B, and wherein the number of slots is 0 if the LBT type is type 2C.

14. One or more processors configured to execute instructions stored in memory to perform operations comprising:
determining a resource selection window for a user equipment (UE), the resource selection window including channel resources for a SL transmission by the UE;
selecting a set of candidate resources in the resource selection window;
determining that a reserved resource of another UE exists in the candidate set of resources;
determining that a selected resource, of the set of candidate resources, is contiguous and prior to the reserved resource; and
applying a partial slot transmission for the selected resource, the partial slot transmission excluding at least one symbol that is planned for transmission in the selected resource.

15. The one or more processors of claim 14, further comprising determining that a CAPC value for the reserved resource is within a pre-specified range of values, wherein the applying the partial slot transmission is based on the determining.

16. The one or more processors of claim 14, further comprising determining that the reserved resource has a higher priority value than another priority value for the UE, wherein the applying the partial slot transmission is based on the determining.

17. The one or more processors of claim 14, wherein the partial slot transmission enables satisfaction of a LBT idle duration for the other UE and transmission by the UE during the selected resource.

18. A method method comprising:
determining a resource selection window for a user equipment (UE), the resource selection window including channel resources for a SL transmission by the UE;
selecting a set of candidate resources in the resource selection window;
determining that a reserved or selected resource for the UE exists in the set of candidate resources;
determine a first subset of candidate resources including resources that are non-contiguous with respect to the reserved resource and a second subset of candidate resources including resources that are contiguous to the reserved resource; and
selecting a resource for SL transmission for the UE, wherein the second subset of candidate resources are prioritized relative to the first subset during the selection.

19. The method of claim 18, wherein the reserved or selected resource and the selected resource have a same source identifier and a same destination identifier.

20. The method of claim 18, wherein the reserved or selected resource and the selected resource are associated with a same CAPC value.

21. The method of claim 18, wherein the reserved or selected resource and the selected resource are associated with different CAPC values.
